(19) United States
(12) Patent Application Publication
(10) Pub. No.: US 2005/0097610 A1
(43) Pub. Date: May 5, 2005

(54) Distribution of preferences, provisioning and entitlements in clustered, distributed entertainment networks

(76) Inventors: Leo M. Pedlow JR., Ramona, CA (US); Eric James Holcomb, San Diego, CA (US); Aran London Sadja, La Jolla, CA (US)

Correspondence Address: MILLER PATENT SERVICES, 2500 DOCKERY LANE, RALEIGH, NC, 27606, US

(21) Appl. No.: 10/797,840

(22) Filed: Mar. 10, 2004

Related U.S. Application Data
(60) Provisional application No. 60/516,711, filed on Nov. 3, 2003.

(51) Int. Cl. H04N 7/16; H04N 7/18; H04L 12/66; H04N 7/173

(52) U.S. Cl. 725/80; 725/74; 725/25; 725/111; 725/116; 725/146

(57) ABSTRACT

A method of configuring a home entertainment network terminal at a subscriber site, consistent with certain embodiments, involves provisioning a home entertainment network terminal by using DHCP services to obtain a unique terminal identifier. The method further involves carrying out a discovery process by attempting to contact each terminal in the sub-domain within the scope defined by DHCP option; and synchronizing a database with a database of the identified terminal. This abstract is not to be considered limiting, since other embodiments may deviate from the features described in this abstract.

### CROSS REFERENCE TO RELATED DOCUMENTS

This application is related to and claims priority benefit of U.S. Provisional Patent Application No. 60/516,711, filed Nov. 3, 2003 to Pedlow Jr., et al., which is hereby incorporated herein by reference. The following references may also be useful in understanding the details of certain embodiments, and are hereby incorporated by reference: Alexander, S. and R. Droms, “DHCP Options and BOOTP Vendor Extensions”, RFC 2132, Internet Engineering Task Force, March 1997; R. Droms, “Dynamic Host Configuration Protocol”, RFC 2131, Internet Engineering Task Force, March 1997; D. Eastlake, 3^{rd}, E. Brunner-Williams and B. Manning, “Domain Name System (DNS) IANA Considerations”, RFC 2929, Internet Engineering Task Force, September 2000.

### COPYRIGHT NOTICE

A portion of the disclosure of this patent document contains material which is subject to copyright protection. The copyright owner has no objection to the facsimile reproduction of the patent document or the patent disclosure, as it appears in the Patent and Trademark Office patent file or records, but otherwise reserves all copyright rights whatsoever.

### BACKGROUND

Present digital cable television systems rely on a traditional client-server topology for distribution of entitlements and other information from the headend to the subscriber terminal. This architecture does not facilitate the migration of the user experience from a terminal located in one room of a dwelling to another. A more seamless, natural environment for the viewer can be realized if a purchased program or a subscriber customized user interface can be made available on any subscriber terminal in a household. Previous attempts to address this issue required significant investment by the cable operator in large, central data centers capable of managing all subscriber terminal settings and key presses in a service area. These systems may be employed to manage more than four million devices at a single center serving a medium sized city.

A previous attempt to commercially implement a system providing the appearance of information migration between subscriber terminals in a household used a “thin client” approach to maintain all subscriber information, including preferences and purchase history, in a centralized data center. In such a “thin client” approach, the data center received every key press from each subscriber terminal in the system and actually made the decision regarding the action to be taken at the subscriber terminal and content to be displayed (menu pages, etc). It also managed the logical grouping of devices assigned to each household. This topology required a massive overbuild of data processing and network resources in order to guarantee system availability and provide reasonable response times under periods of heavy usage. Compounding the design further was lack of precedent to provide actual traffic and usage studies, supporting modeling of such a network. Because of the challenges and costs involved, such architecture is generally considered neither scalable nor commercially viable.

### BRIEF DESCRIPTION OF THE DRAWINGS

Certain illustrative embodiments illustrating organization and method of operation, together with objects and advantages may be best understood by reference detailed description that follows taken in conjunction with the accompanying drawings in which:

FIG. 1 is a block diagram of a profile management system.

FIG. 2 is a block diagram of a profile management system consistent with certain embodiments of the present invention.

FIG. 3 is a simplified block diagram of an exemplary television set top box (terminal) consistent with certain embodiments of the present invention.

FIG. 4 is a flow chart depicting an overall process of provisioning, discovery and synchronization consistent with certain embodiments of the present invention.

FIG. 5 is a flow chart depicting a more detailed embodiment of a discovery process consistent with certain embodiments of the present invention.

FIG. 6 is a flow chart depicting actions of established terminals during the discovery process in a manner consistent with certain embodiments of the present invention.

FIG. 7 is a flow chart depicting a synchronization process for a new terminal being added to a network consistent with certain embodiments of the present invention.

FIG. 8 is a flow chart depicting a synchronization process for an existing terminal in a network consistent with certain embodiments of the present invention.

### DETAILED DESCRIPTION

While this invention is susceptible of embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings.

The terms “a” or “an”, as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically. The term “program”, as used herein, is defined as a sequence of instructions designed for execution on a computer system. A “program”, or “computer program”, may include a subroutine, a function, a procedure, an object method, an object implementation, in an executable application, an applet, a servlet, a source code, an object code, a shared library/dynamic load library and/or other sequence of instructions designed for execution on a computer system. For purposes of this document, the term “terminal” is intended to mean a home entertainment network terminal used for receipt of cable or satellite television programming. In current networks, this terminal is generally in the form of a cable or satellite television set-top box (STB), but it is widely contemplated that the functionality of such STBs will be integrated into normal television receivers in the near future. Accordingly, such devices are also considered to be within the realm of a “terminal” within the meaning of the term's usage herein. Such devices provide decoding, decryption, conditional access and/or other subscription related services to service subscribers. The terms “household” and “subscriber site” may be used interchangeably herein to designate a subscriber site that is assigned a sub-domain under the naming convention to be described. However, it is noted that either a household or a subscriber site may encompass the other term under a given set of network configurations.

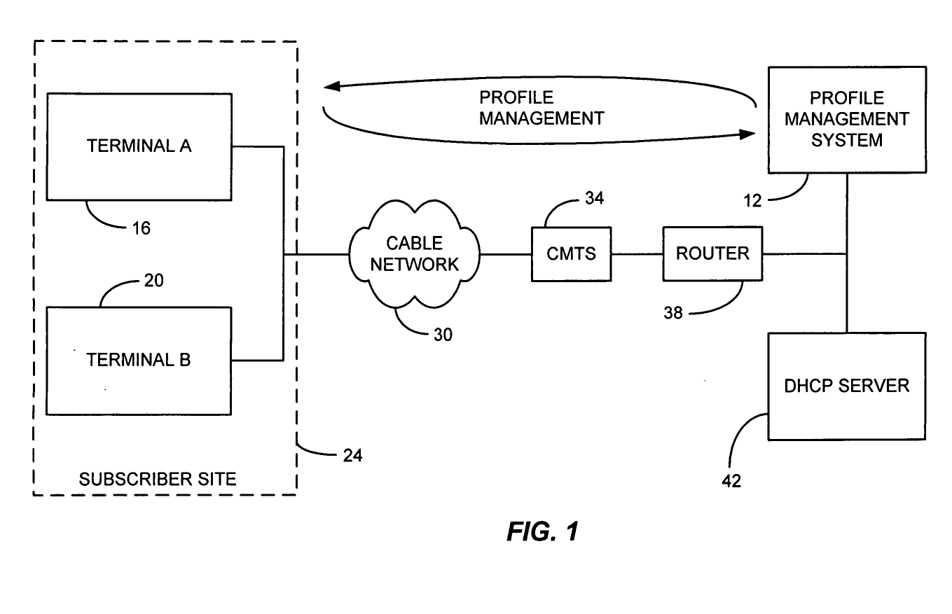

One mechanism for implementing a system providing the appearance of information migration between subscriber terminals in a household is depicted in FIG. 1. In this arrangement, all subscriber information, including preferences and purchase history, is maintained in a centralized data center shown as profile management system 12 (or data center 12). In this arrangement, the television receiver terminals (e.g., television set-top boxes) operate using a “thin client” approach, the profile management system receives every key press from each subscriber terminal 16 and 20 at the subscriber site 24 in the system and actually makes the decision regarding the action to be taken at the subscriber terminal and content to be displayed (menu pages, etc). Profile management system 12 also manages the logical grouping of all devices (e.g., 16 and 20) assigned to each household. In this system, data passes over the cable network between subscriber site 24 and the cable system headend via cable network 30 through cable modem termination system (CMTS) 34 and router 38. Terminals 16 and 20 also connect to a Dynamic Host Configuration Protocol (DHCP) server 42 using this path.

The CMTS is made up of a system of devices located at the headend that permits the MSO (Multiple Service Operator) to provide high-speed Internet access to its subscribers. The CMTS 34 also often provides network management functions. The DHCP server 42 provides the normal services of assigning IP (Internet Protocol) addresses and directing IP traffic.

The topology shown in FIG. 1 suffers from the drawback described above of requiring a massive overbuild of data processing and network resources in order to guarantee system availability and provide reasonable response times under periods of heavy usage. Compounding the design further is a lack of precedent to provide actual traffic and usage studies, supporting modeling of such a network. Because of the challenges and costs involved, such architecture is generally considered neither scalable nor commercially viable.

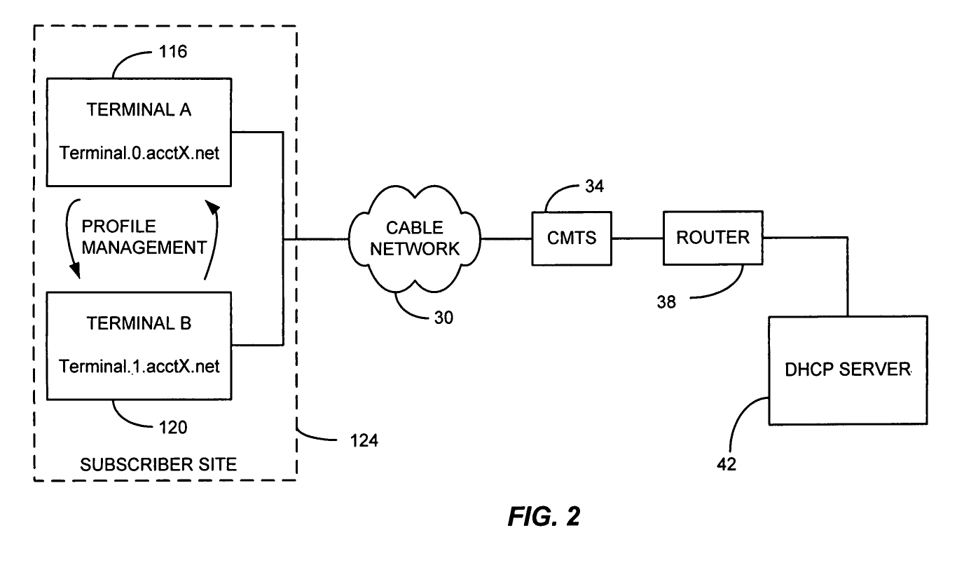

The architecture shown in FIG. 2 addresses these issues and provides extensibility for management of future features and services, including but not limited to application to networks other than digital cable television. Using this architecture, a method and apparatus for sharing data between consumer digital cable television terminals allows the seamless migration of preference, provisioning, active program rental and entitlement data throughout devices in a subscriber's household, while protecting the privacy of such information. Such a feature is desirable in a cable television network since subscriber sites in modern households may have two or more subscriber terminals (STBs). This architecture also provides the ability to have favorite channels, purchases of video on demand (VOD) or pay-per-view (PPV) content propagate throughout the devices in the home without user intervention.

In the architecture of FIG. 2, terminals A and B are depicted as terminals 116 and 120 at a subscriber site 124. A peer-to-peer network arrangement is used to provide distribution of preferences, provisioning and entitlements throughout the subscriber site 124. This process is referred to herein as “Dynamic Distributed Database” (DDD). DDD allows devices in the network to be arbitrarily added or removed from the system without a priori coordination. It is also immune to a dependency that a particular device in the system be available or operating in order for the DDD process to work, a common issue in consumer devices since they may be turned on or off at any time.

Some of the biggest challenges in creating a practical topology for a distributed database in such environments are those encountered in the processes of discovery of connected devices and synchronization of data across the multiple devices. These two issues are addressed in certain embodiments consistent with the present invention. The DDD design works within, but is not limited to, a standard Data-Over-Cable System Interface Specification (DOCSIS) compliant cable modem network topology, which is widely deployed in both the North American and European cable television markets and is present in commercially available standalone devices and television set-top boxes. The operation of a DOCSIS compliant cable modem is detailed in “Data-Over-Cable Interface Specifications: Radio Frequency Interface Specification”, available from Cable Labs as specification SP-RFIv1.1-I08-020301:2002.

One can define three zones of standard broadband cable architecture, the core network, aggregation network, and the access network. The core network is defined as the operator's backbone linking their subscribers to the operator defined services, provisioning servers, and the Internet. The aggregation network is the zone that combines all traffic from subscriber terminal devices on the access network. The access network in the DDD system is the DOCSIS network itself. Using a peer-to-peer scheme to implement DDD limits additional traffic to the access network only, alleviating the traffic burden upon the aggregation and core networks that existed in previous client server based designs, to migrate relative data between logically oriented subscriber terminals. The peer-to-peer topology also eliminates any single point of failure preventing service delivery, a common problem presented by standard client-server models.

Certain embodiments consistent with certain embodiments of the present invention provide a method to implement and manage this information, making the propagation of purchased (PPV) programming, room to room migration of Video on Demand (VOD) and self-provisioning a practical reality with a minimum of additional support equipment, avoiding an investment in a massive central datacenter to support these capabilities. One of the challenges faced is the definition and management of subscriber terminals in a logical cluster representing a household and how a newly added device is detected by other existing units in a household and receives information indicating its association.

Using a consistent provisioning scheme, subscriber terminals within a household can be inherently grouped. Constructing such groupings will allow subscribers within the same household to share terminal preferences, provisioning and entitlements in a peer-to-peer fashion. By utilizing options 43, 15, and 12 defined in the Dynamic Host Configuration Protocol (DHCP) and by incorporating the Domain Name System (DNS), household environments can be established and managed. The reader's attention is directed to published specifications detailing DHCP operation for details of the operation of these options that are described briefly below.

DHCP option 43, vendor-specific information, is used in this design to define the scope i.e. the number of possible terminals in a subscriber site. Defining such a scope limits the number of potential peers a subscriber terminal will seek during the discovery process, reducing network traffic during this phase.

The domain name, DHCP option 15, provides the unique sub-domain name for each subscriber site (e.g., household). This will define each household on the network and allow a standard hostname convention to be used network wide. In one embodiment, the subscriber's account number or other identifier can be used as all or part of the domain name.

The hostname, DHCP option 12, is utilized to deliver a standardized hostname to the terminal devices. The naming convention for the hostname will allow the terminal to parse it's own hostname and from it, determine the names of its possible peers, i.e. terminal_n, where n is an integer constrained by the expression 0≦n ≦household_scope. The variable household_scope is an operator configurable limit to minimize traffic during discovery. It would be typically set to a value of eight since it is unlikely that there would be more than eight subscriber terminal devices in a particular household. If the demographics of the subscribers in a particular network indicate that there may be more than eight devices per household or other subscriber site, then the value can be increased by the system operator as appropriate. The standard hostname convention in conjunction with the unique sub domain name will inherently allow these terminals to discover their sub-domain peers allowing dynamic shared access to related data.

The domain name assigned using DHCP option 15 is appended to the hostname defined in DHCP option 12 to create a fully qualified hostname. When a subscriber terminal device makes a request to the domain name system (DNS) to resolve a hostname to a TCP/IP address, it looks in the default domain field, which is common to all terminals in the same subscriber site. This allows all terminals on the network using an identical naming convention to resolve only the terminals in its own subscriber site.

Thus, for the example shown in FIG. 2, if the subscriber site is assigned a domain name of “acctX.net” (where, for example, the subscriber's account number or other identifier is used as the domain name), terminal 116 can be identified in the network by the address “Terminal.0.acctX.net”. Similarly, terminal 120 can be identified in the network by the address “Terminal.1.acctX.net”. In this example, only two terminals are present in the household, making resolving the terminals a simple matter. Resolving up to any likely number of terminals in a single household is similarly a simple task due to the low number of terminals at any given subscriber site.

Discovery is the process of determining available peers within the same logically defined subscriber site. Once subscriber terminal devices have received the proper provisioning information via DHCP, they begin the discovery process. Using standardized pre-defined hostnames (e.g. terminal_n) and the household_scope variable, the terminal device begins connection attempts to discover household peers. The search begins with terminal_{—}0 and iterates within the bounds of the household_scope variable. In the discovery process, DNS requests to resolve hostnames are restricted to the households' unique sub-domain, thus limiting the resulting addresses to terminals within the subscriber site. In the discovery process, DNS requests to resolve hostnames are restricted to the households' unique sub-domain, thus limiting the resulting addresses to terminals within the subscriber site. Successful discovery attempts result in the addition of a household member to both the requesting and the responding terminal's peer lists. Each terminal maintains its own peer list, which is vital to the synchronization process, as described later. The peer lists are updated as connections succeed and fail between household peers. In addition, there will be a periodic discovery at pre-determined intervals in order to maintain a valid up-to-date peer lists.

Using provisioning and discovery information, along with a common time source such as that supplied by the standard TOD (Time of Day) service using DOCSIS, terminals within a household send synchronization queries to peers whenever local updates occur. When a new terminal with an empty database joins a household, the lowest ordered terminal in the peer list will provide complete database synchronization i.e. the entire database is transmitted to the “empty” device, including the versioning timestamp from the source device. Once the terminal device has a populated database, it becomes an active peer in the household and from this point forward all updates will use the network-supplied time to create a common timestamp as the database version indicator, assuring database synchronicity.

When a terminal within a household makes a local change to shared information, the change is transmitted to all terminals on the peer list. The receiving terminal verifies each update query, prohibiting a conflicting overwrite of a record with a more current local timestamp. A failed update to any peer results in the update information being stored in a local update queue with a timestamp, and the failed peer is marked ‘out-of-sync’ on the peer list. While there is a terminal on the out-of-sync list, the queued updates are retransmitted to the un-synchronized peer(s) on progressively longer intervals until the update is successful or a specified time-out period passes (or a number of retry attempts have been made, etc.). If a terminal times-out, the terminal is removed from the peer list of the device attempting to contact it and no further attempts are made to communicate with it. When a terminal has an empty peer list (sole device in a household), synchronization efforts are unnecessary and are suspended, while the periodic discoveries continue.

As insurance that the peer list is synchronized and all bone fide devices in a household are accounted for, a periodic “maintenance window” is created, wherein all devices rediscover its peers. This process occurs at an operator-defined interval (e.g., daily or weekly) and at a time where network traffic is statistically low, such as in the middle of the night on a weeknight. The rediscovery process is fast and the duration of such an event is brief. The maintenance window can be defined such that various households are staggered in both time of occurrence as well as day of week to further balance network traffic.

In the event of communication loss between all terminals, each maintains its own update queue. When network communication is restored, the process of updating each peer commences, each update being verified individually until all peers have achieved synchronization. In the extreme case of network loss for a length of time beyond that of the specified period of unresponsiveness, where each terminal has emptied its peer list, the terminal with the most current database timestamp will supply its peers with complete database synchronization.

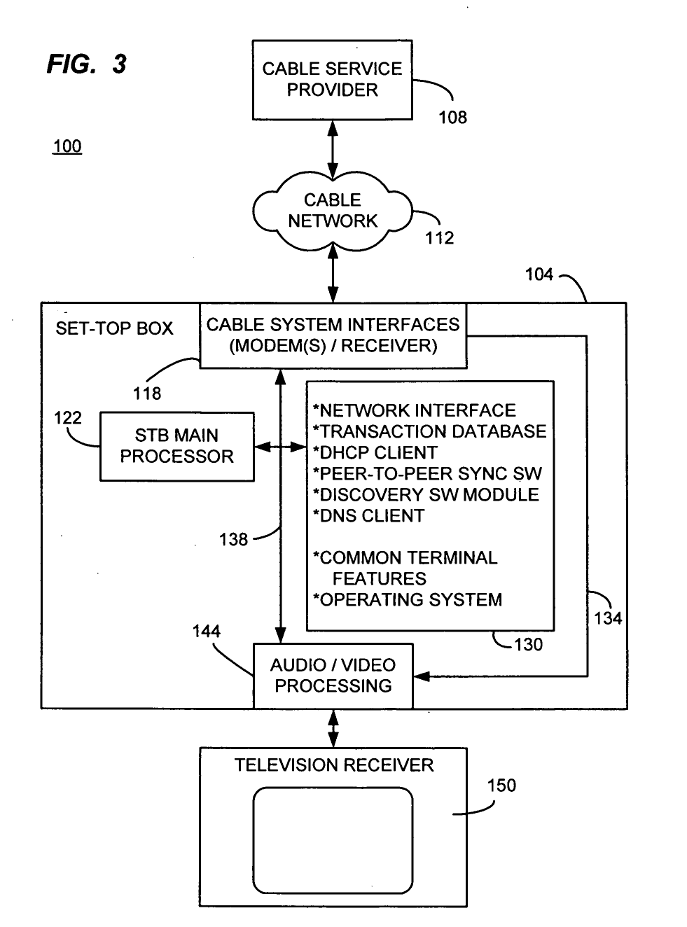

Turning now to FIG. 3, a simplified block diagram of an exemplary cable television arrangement 100 with an exemplary terminal (i.e., Set-Top Box) 104 is illustrated. Only a single terminal is depicted within this illustration for clarity, but it will be understood that multiple terminals are present in order to fully utilize certain embodiments consistent with the present invention. Terminal STB 104 connects to a cable system service provider 108 via a cable network 112. An interface to the cable system is provided at STB 104 in the form of a television receiver (tuner) as well as in-band and out-of-band modems, collectively shown as interfaces 118. Terminal 104 incorporates an internal main processor 122 with associated memory 130 (e.g., a combination of one or more of RAM, ROM and FLASH memory as well as disk drive storage). The processor 122 is interconnected with the associated memory 130 in a conventional manner using a single or multiple bus connections depicted as 138. Audio and video information is received via signal path 134 and processed using audio/video (A/V) processing circuitry 144 that receives such A/V signals from the cable system interface 118. The processed A/V information is then delivered to a television receiver 150 or monitor and audio system for presentation to the user.

The terminal 104, as previously described, is implemented so as to incorporate functional elements consistent with certain embodiments as software or firmware blocks residing within memory 130. In addition to the operating system and software defining the common operational features of the terminal, the memory stores functional blocks of code that implement a network interface, the transaction database used to maintain awareness and synchronization among the various terminals within the sub-domain of the subscriber site, a DHCP client, a peer-to-peer synchronization software module, a discovery software module and a DNS client. Of course other software functionality can also be stored on the memory 130 without limitation.

While the above exemplary system including STB 104 is illustrative of the basic components of a digital Set-Top Box suitable for use with the present invention, the architecture shown should not be considered limiting since many variations of the hardware configuration are possible without departing from the present invention. The present invention could, for example, also be implemented in more advanced architectures such as that disclosed in U.S. patent application Ser. No. 09/473,625, filed Dec. 29, 1999, Docket No. SONY-50N3508 entitled “Improved Internet Set-Top Box Having and In-Band Tuner and Cable Modem” to Jun Maruo and Atsushi Kagami. This application describes a STB using a multiple bus architecture with a high level of encryption between components for added security. This application is hereby incorporated by reference as though disclosed fully herein.

Thus, a home entertainment network terminal, consistent with certain embodiments has a network interface that receives content and data from a network. A display interface carries content from the network to a display for viewing by a user. A database is provided. A processor is coupled to the network interface and operates under program control to: provision the home entertainment network terminal by using network DHCP services to obtain a unique terminal identifier, wherein the DHCP services use DHCP option 43 to define a scope of the subscriber site, wherein the DHCP services use DHCP option 15 to define a unique sub-domain name for the subscriber site, and wherein the DHCP services use DHCP option 12 to define a common host name for the terminal; carry out a discovery process by attempting to contact each terminal in the sub-domain within the scope defined by DHCP option; and for at least one terminal identified in the discovery process, synchronize the database with a database of the identified terminal. In other embodiments, a home entertainment network terminal has a circuit for provisioning by using DHCP services to obtain a unique terminal identifier. The terminal further has a circuit for carrying out a discovery process by attempting to contact each terminal in the sub-domain within the scope defined by DHCP option. The terminal further has a circuit for synchronizing a database with a database of the identified terminal. Many variations will occur to those skilled in the art upon consideration of this teaching.

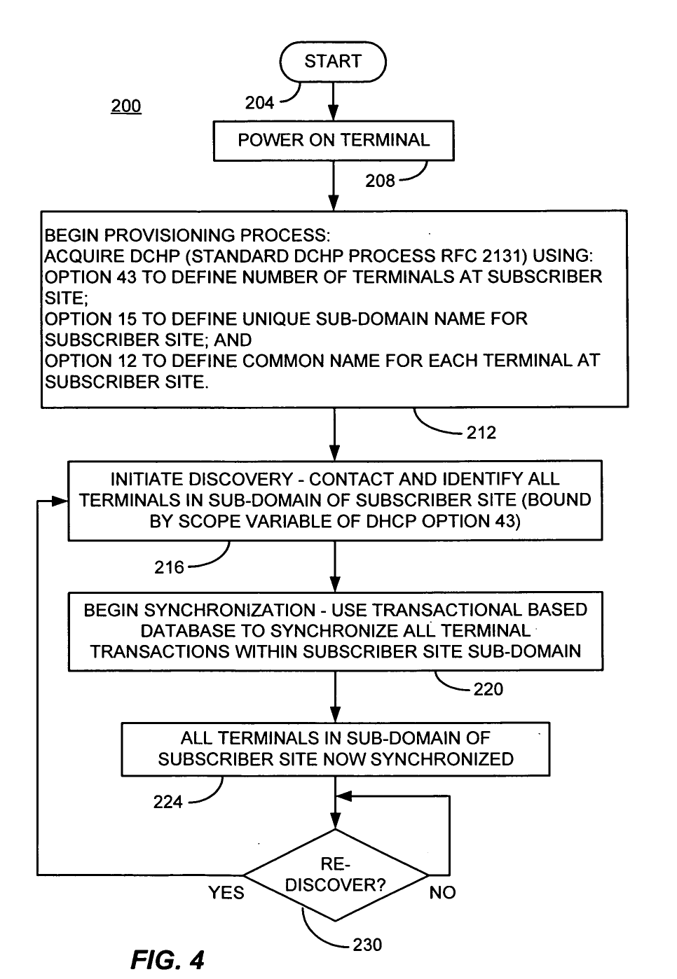

By running the software in memory 130, terminal 104 can carry out the DDD process depicted as 200 incorporating the provisioning, discovery and synchronization processes consistent with certain embodiments can be initiated in the manner depicted in FIG. 4 starting at 204. At 208, a terminal is powered on to initiate the DDD process. At 212, the initial provisioning stage is initiated in which DCHP options 43, 15 and 12 are used to define a unique name for the terminal that will be consistent with the terminal naming convention established for a sub-domain that encompasses the subscriber site. At 216, once the terminal has been appropriately identified, the discovery process is initiated. This is accomplished by systematically attempting to contact each of the other terminals in the sub-domain, as bound by the scope defined in DHCP option 43. For each other terminal in the sub-domain identified in 216, the terminal synchronizes it's transactional based database to assure that all terminals contain an identically time stamped and populated set of database entries at 220. Thus, at 224, all terminals within the sub-domain are provisioned and synchronized. To assure continued synchronization, a timed re-discovery process is initiated, preferably at a time of low network use. When the re-discovery time arrives at 230, the process reverts to 216 to re-initiate a discovery thereby assuring continued synchronization of all terminals.

Thus, a method of configuring a home entertainment network terminal at a subscriber site, consistent with certain embodiments, involves provisioning a home entertainment network terminal by using DHCP services to obtain a unique terminal identifier. The method further involves carrying out a discovery process by attempting to contact each terminal in the sub-domain within the scope defined by DHCP option; and synchronizing a database with a database of the identified terminal. A method of configuring a home entertainment network terminal at a subscriber site, consistent with other embodiments involves provisioning a home entertainment network terminal by using DHCP services to obtain a unique terminal identifier, wherein the DHCP services use DHCP option 43 to define a scope of the subscriber site, wherein the DHCP services use DHCP option 15 to define a unique sub-domain name for the subscriber site, and wherein the DHCP services use DHCP option 12 to define a common host name for the terminal; carrying out a discovery process by attempting to contact each terminal in the sub-domain within the scope defined by DHCP option; and for at least one terminal identified in the discovery process, synchronizing a database with a database of the identified terminal.

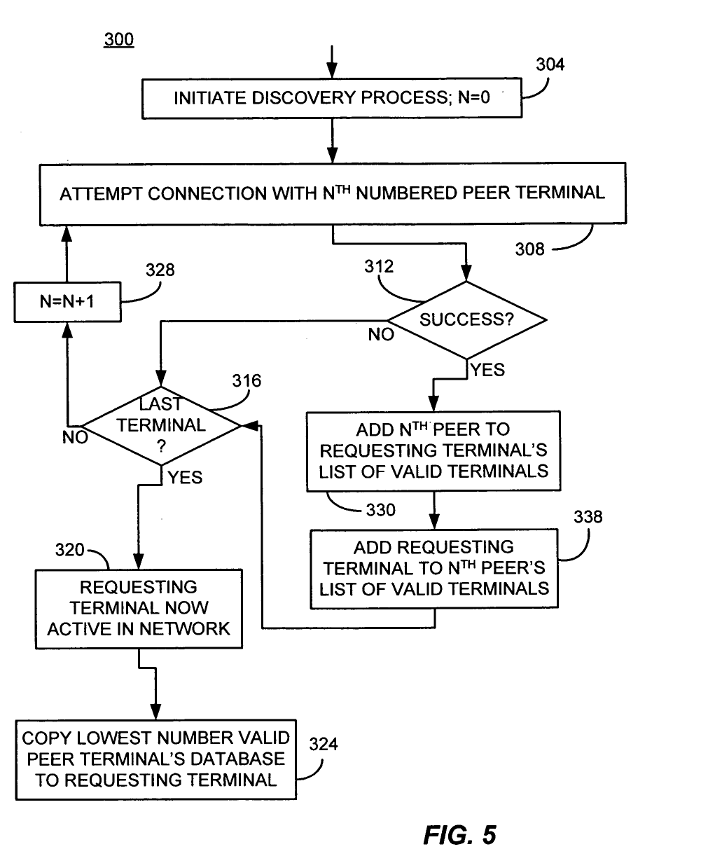

When a new terminal is added to the network, it behaves, in certain embodiments, according to process 300 depicted in FIG. 5 in order to initiate the discovery process (after the new terminal is provisioned as described above. The discovery process is initiated at 304 with a terminal number or terminal order N initialized to 0. At 308, an attempt is made to connect and communicate with the 0^{th} terminal in the sub-domain of the subscriber site. If this attempt does not meet with success at 312, a determination is made regarding whether or not the current N^{th} terminal represents the last terminal in the sub-domain at 316. When this last terminal is encountered, the current terminal becomes active in the network at 320 and the lowest ordered valid terminal copies it's database to the current (requesting) terminal at 324 and the process of discovery is completed. Until connection is attempted with this last terminal in the sub-domain, the value of N (the terminal number or order) is incremented at 328 and control returns to 308 where an attempt is made to contact the next terminal.

Whenever a terminal is successfully contacted at 312, this terminal (the current N^{th} terminal) is added to the requesting terminal's list of valid terminals at 330. Failure to successfully connect to a terminal results in the terminal being listed as invalid in the terminal's list of valid terminals. At 338, the requesting terminal is similarly added to the N^{th} terminal's list of valid terminals so that both terminals are able to communicate with one another. Control then returns from 338 to 316 and the process proceeds until the last terminal in the sub-domain is reached. It is noted, and will be understood by those skilled in the art upon consideration of the present teaching, that the process just describes begins the search at 0 and proceeds to the highest order terminal number, but the search could equally well proceed from highest to lowest or could proceed in any other systematic manner without departing from certain embodiments. Moreover, while the present embodiment uses the lowest ordered terminal as a source for copying database data, the highest or any other terminal could also be used.

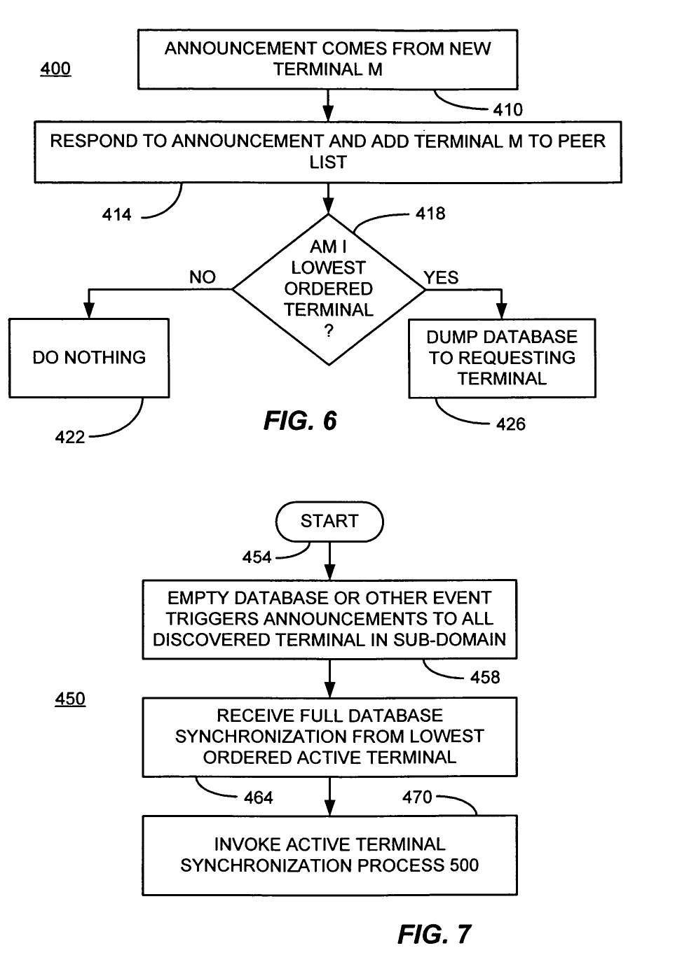

FIG. 6 depicts this exemplary discovery process 400 from the perspective of an existing active terminal when a new terminal is entering the network. At 410 an announcement from the new terminal (terminal M) is received addressing the current active terminal. The current active terminal responds to the announcement and adds terminal M to it's list of active peer terminals. The process then proceeds to 418, where the current terminal determines if it is the lowest ordered active terminal. If not, no action is taken at 422. If so, the current active terminal's database is sent to terminal M using peer-to-peer communications at 426.

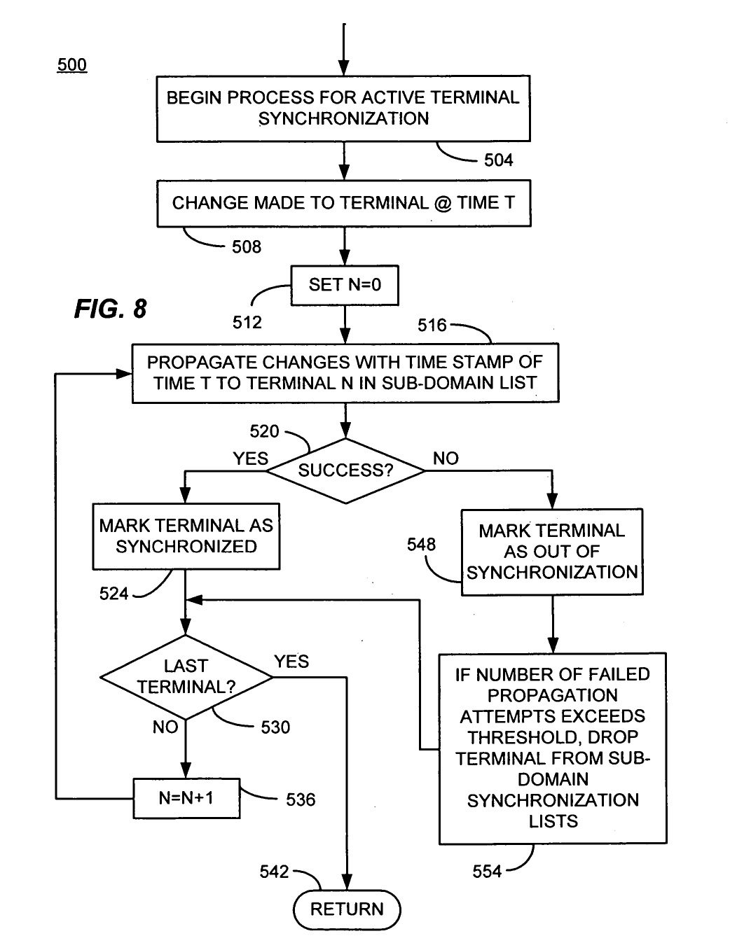

The synchronization process 450 is further described by the process of FIG. 7 starting at 454. The synchronization process, in general, is initiated whenever a terminal determines that it has an empty database, has a database that does not have the latest time stamp in the network or is otherwise initiated (e.g., by user intervention, or by virtue of a timed event designed to assure synchronization as described previously) at 458. When this happens, the terminal communicates with the lowest ordered (or according to another embodiment, to the highest numbered or ordered) active terminal to receive a database update at 464 by invoking the active terminal synchronization process 500 of FIG. 8.

The process 500 of FIG. 8 begins at 504. At 508 a change is made to the database of the current terminal at time T. This database, of course, determines the functionality of the terminal (e.g., conditional access and subscription related rights). Time T is a system-derived time derived from a common source for all terminals and is used as a time stamp to assure synchronization. The process starts, in this example, with terminal number 0, so at 512, N (the terminal number) is set to 0. The database of each terminal within the sub-domain of the subscriber site is updated by providing the changes to each terminal along with the time stamp at 516.

If the change is successfully propagated at 520, the terminal N is marked as synchronized at 524. The new data and time stamp are recorded at 524 so that all successful propagations are kept in synchronization. Assuming terminal N is not the last terminal at 530, N is incremented at 536 and control returns to 516 to propagate changes to the next terminal.

If an attempted propagation is unsuccessful at 520, it is marked as out of synchronization at 548. Propagation is retried for a specified number of attempts at 554 (or period of time). If the propagation of new database content is unsuccessful after the threshold maximum number of attempts (or time out, etc.) is reached or exceeded at 554, the unsuccessfully updated terminal is dropped from the sub-domain's synchronization lists at 554. Although not shown in this figure, if prior to reaching the maximum number of retries at 554, propagation is successful, control passes over to 524 and the terminal can be marked as synchronized. If a failed propagation persists at 554, control passes to 530 and the process proceeds as described previously.

Utilizing a peer-to-peer topology as described above overcomes some of the scalability issues of a client-server model that have been previously seen in a cable TV environment. With a centrally located database, each key press on every subscriber terminal is transmitted to the central facility and as a result massive traffic peaks are experienced, directly related to customer TV viewing habits. These peaks congest the aggregation and core network access to all customers, requiring the service provider to overbuild these networks to handle the prime time peaks. Limiting the database related traffic to the only the DOCSIS network scales well. Even the highest amount of traffic will not affect the backend networks, The periodic discovery defined earlier, which optimizes the network by keeping accurate peer lists, is scheduled at low traffic periods to further reduce network loading. This model requires the same amount of traffic for updates as the traditional client-server model, but limits that traffic to the DOCSIS network and additionally provides a greater level of redundancy based on the number of terminals in the household

By having distributed dynamic databases implemented in individual subscriber terminal devices, consumers can realize both capabilities and convenience levels never before seen in cable television offerings. Capabilities such as the automated propagation of favorite channels, preferences, locks and limits between all subscriber terminal devices in the same household are achievable, as is the migration of purchased pay-per-view and video-on-demand programming, enabling a single household purchase of a program to be seen, if permitted by the operator, in all rooms of the same household. This capability comes without the need for a significant capital expenditure for a central data processing center to host the database for each household, while maintaining both network and user data security. Because the base communications protocol is rooted in DOCSIS and TCP/IP, the infrastructure most likely already exists at the majority of cable operators. The design of the DDD processes for discovery and synchronization are designed to simultaneously minimize both network traffic and the processing resources required in the subscriber terminal devices to host a DDD based system. Their autonomous nature avoids additional operator intervention and workload to establish or maintain. As a result, the new features and capabilities can be provided to consumers without a significant capital investment by the operator in either infrastructure or new subscriber terminals. This opportunity will continue to provide new methods for cable operators to differentiate themselves from the satellite industry in order to gain as well as retain subscribers.

Those skilled in the art will recognize, upon consideration of the above teachings, that certain of the above exemplary embodiments are based upon use of a programmed processor such as 122 or other processor within the terminal. However, the invention is not limited to such exemplary embodiments, since other embodiments could be implemented using hardware component equivalents such as special purpose hardware and/or dedicated processors. Similarly, general purpose computers, microprocessor based computers, micro-controllers, optical computers, analog computers, dedicated processors, application specific circuits and/or dedicated hard wired logic may be used to construct alternative equivalent embodiments.

Those skilled in the art will appreciate, upon consideration of the above teachings, that the program operations and processes and associated data used to implement certain of the embodiments described above can be implemented using disc storage as well as other forms of storage such as for example Read Only Memory (ROM) devices, Random Access Memory (RAM) devices, network memory devices, optical storage elements, magnetic storage elements, magneto-optical storage elements, flash memory, core memory and/or other equivalent volatile and non-volatile storage technologies without departing from certain embodiments of the present invention. Such alternative storage devices should be considered equivalents.

Certain embodiments described herein, are or may be implemented using a programmed processor executing programming instructions that are broadly described above in flow chart form that can be stored on any suitable electronic or computer readable storage medium and/or can be transmitted over any suitable electronic communication medium. However, those skilled in the art will appreciate, upon consideration of the present teaching, that the processes described above can be implemented in any number of variations and in many suitable programming languages without departing from embodiments of the present invention. For example, the order of certain operations carried out can often be varied, additional operations can be added or operations can be deleted without departing from certain embodiments of the invention. Error trapping can be added and/or enhanced and variations can be made in user interface and information presentation without departing from certain embodiments of the present invention. Such variations are contemplated and considered equivalent.

While certain embodiments herein were described in conjunction with specific circuitry that carries out the functions described, other embodiments are contemplated in which the circuit functions are carried out using equivalent software or firmware embodiments executed on one or more programmed processors. General purpose computers, microprocessor based computers, micro-controllers, optical computers, analog computers, dedicated processors, application specific circuits and/or dedicated hard wired logic and analog circuitry may be used to construct alternative equivalent embodiments. Other embodiments could be implemented using hardware component equivalents such as special purpose hardware and/or dedicated processors.

Software and/or firmware embodiments may be implemented using a programmed processor executing programming instructions that in certain instances are broadly described above in flow chart form that can be stored on any suitable electronic or computer readable storage medium (such as, for example, disc storage, Read Only Memory (ROM) devices, Random Access Memory (RAM) devices, network memory devices, optical storage elements, magnetic storage elements, magneto-optical storage elements, flash memory, core memory and/or other equivalent volatile and non-volatile storage technologies) and/or can be transmitted over any suitable electronic communication medium. However, those skilled in the art will appreciate, upon consideration of the present teaching, that the processes described above can be implemented in any number of variations and in many suitable programming languages without departing from embodiments of the present invention. For example, the order of certain operations carried out can often be varied, additional operations can be added or operations can be deleted without departing from certain embodiments of the invention. Error trapping can be added and/or enhanced and variations can be made in user interface and information presentation without departing from certain embodiments of the present invention. Such variations are contemplated and considered equivalent.

While certain illustrative embodiments have been described, it is evident that many alternatives, modifications, permutations and variations will become apparent to those skilled in the art in light of the foregoing description.

1. A method of configuring a home entertainment network terminal at a subscriber site, comprising:
provisioning the home entertainment network terminal by using DHCP services to obtain a unique terminal identifier, wherein the DHCP services use DHCP option 43 to define a scope of the subscriber site, wherein the DHCP services use DHCP option 15 to define a unique sub-domain name for the subscriber site, and wherein the DHCP services use DHCP option 12 to define a common host name for the terminal;
carrying out a discovery process by attempting to contact each terminal in the sub-domain within the scope defined by DHCP option; and
for at least one terminal identified in the discovery process, synchronizing a database with a database of the identified terminal.

2. The method according to claim 1, wherein the synchronizing comprises synchronizing to an identified terminal having a database carrying a most recent time stamp.

3. The method according to claim 1, wherein the synchronizing comprises synchronizing to an identified terminal having either a lowest or highest ordered identifier.

4. The method according to claim 1, wherein the database comprises a transactional based database.

5. The method according to claim 1, further comprising determining that a re-discovery time has arrived and repeating the carrying out the discovery process and the synchronizing.

6. The method according to claim 1, further comprising listing an identified terminal in a list of active terminals in the sub-domain.

7. The method according to claim 1, wherein the discovery process further comprises attempting unsuccessfully to contact a terminal, and marking the unsuccessfully contacted terminal as invalid on a list of active terminals in the sub-domain.

8. The method according to claim 1, wherein the discovery process further comprises carrying out a specified number of attempts to contact a terminal, and if the terminal is not successfully contacted within the specified number of attempts, marking the unsuccessfully contacted terminal as invalid on a list of active terminals in the sub-domain.

9. A method of configuring a home entertainment network terminal at a subscriber site, comprising:
provisioning the home entertainment network terminal by using DHCP services to obtain a unique terminal identifier, wherein the DHCP services use DHCP option 43 to define a scope of the subscriber site, wherein the DHCP services use DHCP option 15 to define a unique sub-domain name for the subscriber site, and wherein the DHCP services use DHCP option 12 to define a common host name for the terminal;
carrying out a discovery process by attempting to contact each terminal in the sub-domain within the scope defined by DHCP option;
for at least one terminal identified in the discovery process, synchronizing a transactional based database with a database of the identified terminal, the identified terminal having a database carrying a most recent time stamp, and wherein the identified terminal has either a lowest or highest ordered identifier;
listing the identified terminal in a list of active terminals in the sub-domain; and
determining that a re-discovery time has arrived and repeating the carrying out the discovery process and the synchronizing.

10. The method according to claim 9, wherein the discovery process further comprises carrying out a specified number of attempts to contact a terminal, and if the terminal is not successfully contacted within the specified number of attempts, marking the unsuccessfully contacted terminal as invalid on a list of active terminals in the sub-domain.

11. A home entertainment network terminal, comprising:
a network interface that receives content and data from a network;
a display interface that carries content from the network to a display for viewing by a user;
a database;
a processor, coupled to the network interface, that operates under programmed control to:
provision the home entertainment network terminal by using network DHCP services to obtain a unique terminal identifier, wherein the DHCP services use DHCP option 43 to define a scope of the subscriber site, wherein the DHCP services use DHCP option 15 to define a unique sub-domain name for the subscriber site, and wherein the DHCP services use DHCP option 12 to define a common host name for the terminal;
carry out a discovery process by attempting to contact each terminal in the sub-domain within the scope defined by DHCP option; and
for at least one terminal identified in the discovery process, synchronize the database with a database of the identified terminal.

12. The home entertainment network terminal according to claim 11, wherein the synchronizing comprises synchronizing to an identified terminal having a database carrying a most recent time stamp.

13. The home entertainment network terminal according to claim 11, wherein the synchronizing comprises synchronizing to an identified terminal having either a lowest or highest ordered identifier.

14. The home entertainment network terminal according to claim 11, wherein the database comprises a transactional based database.

15. The home entertainment network terminal according to claim 11, wherein the processor further operates under program control to determine that a re-discovery time has arrived and repeating the carrying out the discovery process and the synchronizing.

16. The home entertainment network terminal according to claim 11, wherein the processor further operates under program control to list an identified terminal in a list of active terminals in the sub-domain.

17. The home entertainment network terminal according to claim 11, wherein the processor further operates under program control to determine that an attempt to contact a terminal was unsuccessful, and to mark the unsuccessfully contacted terminal as invalid on a list of active terminals in the sub-domain.

18. The home entertainment network terminal according to claim 11, wherein the processor further operates under program control to carrying out a specified number of attempts to contact a terminal, and if the terminal is not successfully contacted within the specified number of attempts, mark the unsuccessfully contacted terminal as invalid on a list of active terminals in the sub-domain.

19. A home entertainment network terminal, comprising:
means for provisioning the home entertainment network terminal by using DHCP services to obtain a unique terminal identifier;
means for carrying out a discovery process by attempting to contact each terminal in the sub-domain within the scope defined by DHCP option; and
means for synchronizing a database with a database of the identified terminal.

20. The home entertainment network terminal according to claim 19, wherein the DHCP services use DHCP option 43 to define a scope of the subscriber site, wherein the DHCP services use DHCP option 15 to define a unique sub-domain name for the subscriber site, and wherein the DHCP services use DHCP option 12 to define a common host name for the terminal.

21. The home entertainment network terminal according to claim 19, wherein the synchronizing comprises synchronizing to an identified terminal having a database carrying a most recent time stamp.

22. The home entertainment network terminal according to claim 19, wherein the synchronizing comprises synchronizing to an identified terminal having either a lowest or highest ordered identifier.

23. The home entertainment network terminal according to claim 19, further comprising means for determining that a re-discovery time has arrived and repeating the carrying out the discovery process and the synchronizing.

24. The home entertainment network terminal according to claim 19, further comprising means for listing an identified terminal in a list of active terminals in the sub-domain, and marking an unsuccessfully contacted terminal as invalid on the list of active terminals in the sub-domain.

25. The home entertainment network terminal according to claim 19, wherein the terminal comprises a television set-top box.

26. A computer readable storage medium storing instructions which, when executed on a programmed processor, carry out a process of configuring a home entertainment network terminal at a subscriber site, comprising:
provisioning a home entertainment network terminal by using DHCP services to obtain a unique terminal identifier;
means for carrying out a discovery process by attempting to contact each terminal in the sub-domain within the scope defined by DHCP option; and
means for synchronizing a database with a database of the identified terminal.

27. The storage medium according to claim 26, wherein the DHCP services use DHCP option 43 to define a scope of the subscriber site, wherein the DHCP services use DHCP option 15 to define a unique sub-domain name for the subscriber site, and wherein the DHCP services use DHCP option 12 to define a common host name for the terminal.

28. The storage medium according to claim 26, wherein the synchronizing comprises synchronizing to an identified terminal having a database carrying a most recent time stamp.

29. The storage medium according to claim 26, wherein the synchronizing comprises synchronizing to an identified terminal having either a lowest or highest ordered identifier.

30. The storage medium according to claim 26, further comprising means for determining that a re-discovery time has arrived and repeating the carrying out the discovery process and the synchronizing.

31. The storage medium according to claim 26, further comprising means for listing an identified terminal in a list of active terminals in the sub-domain, and marking an unsuccessfully contacted terminal as invalid on the list of active terminals in the sub-domain.

32. A method of configuring a home entertainment network terminal at a subscriber site, comprising:
provisioning a home entertainment network terminal by using DHCP services to obtain a unique terminal identifier;
carrying out a discovery process by attempting to contact each terminal in the sub-domain within the scope defined by DHCP option; and
synchronizing a database with a database of the identified terminal.

33. The method according to claim 32, wherein the DHCP services use DHCP option 43 to define a scope of the subscriber site, wherein the DHCP services use DHCP option 15 to define a unique sub-domain name for the subscriber site, and wherein the DHCP services use DHCP option 12 to define a common host name for the terminal.

34. The method according to claim 32, wherein the synchronizing comprises synchronizing to an identified terminal having a database carrying a most recent time stamp.

35. The method according to claim 32, wherein the synchronizing comprises synchronizing to an identified terminal having either a lowest or highest ordered identifier.

36. The method according to claim 32, further comprising determining that a re-discovery time has arrived and repeating the carrying out the discovery process and the synchronizing.

37. The method according to claim 32, further comprising listing an identified terminal in a list of active terminals in the sub-domain, and marking an unsuccessfully contacted terminal as invalid on the list of active terminals in the sub-domain.
